(19) United States
(12) Patent Application Publication
(10) Pub. No.: US 2005/0256968 A1
(43) Pub. Date: Nov. 17, 2005

(54) Delaying browser requests

(76) Inventor: Teddy C. Johnson, Issaquah, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/844,029

(22) Filed: May 12, 2004

(51) Int. Cl. G06F 15/16

(52) U.S. Cl. 709/232; 709/219

(57) ABSTRACT

One embodiment of the invention is a method of responding to a browser request by a server comprising: reading a current load factor for the server; determining a quality of service level for a user that originated the browser request; determining a delay based upon the current load factor and the quality of service; delaying handling of the request by the server with the delay.

### FIELD OF THE INVENTION

This application relates in general to networks, and in specific to a system and method that provides multiple levels of quality of service and protects against distributed denial of service attacks.

### DESCRIPTION OF THE RELATED ART

Prior servers allows for a user to initiate a HTTP (hyper text transfer protocol) session. The user begins accessing the login page of the desired web site with a web browser located on the user's computer. The user enters a user name and password. The server invokes a login script to handle the login request from the user. The login script uses a database access routine to retrieve the user's account information. If there are no records corresponding to the user name, the script sends an error message, e.g. access denied. If the password for the user name is incorrect, then the script sends an error message, e.g. access denied. If there are records corresponding to the user name and the password is correct, then the script retrieves a copy of the customer record from the database. The script then locates a free block of shared memory, and stores the copy of the customer record. The script then sends a cookie back to the browser of the user that includes a pointer to the assigned shared memory block.

The customer record stored in the shared memory may include a list of services that is available to the user. Thus, when user desires to perform a service on the web site, the customer record is consulted. For example, a user desires to search the web site for a program patch. The user would enter program patch in the search fields and click submit. The user's browser would send the search along with the cookie to the web site's server. The request invokes a script which reads the cookie and extracts the pointer for the shared memory block. The script would then access the customer record in the shared memory block and determine if the user is allowed to access the requested service, in this case search for a program patch. If so, then the script performs the service, i.e. performs the search, and returns the results to the user. If not, then the script may return an error message, e.g. sorry your service contract does not allow access to this service.

The shared memory may be RAM memory (random access memory). The user's customer record may be retained in the shared memory for several hours, e.g. 24 hours. Thus, a user when accessing the web site again would be able to use the cookie and perform tasks without having to re-establish the shared memory block. A garbage collection mechanism frees up shared memory space as needed.

Prior servers are subject to distributed denial of service (DDOS) attacks from hackers and/or predatory programs, e.g. viruses. A DDOS typically involves hundreds or thousands of hackers or computers infected with predatory programs that begin making access requests at the same time. This overwhelms the victim web site with legitimate requests, and thus causes a “denial of service” to legitimate uses of that web site. The DDOS causes the server to slow down, and possibly crash. The crash occurs when the back-end servers have too much load, e.g. exhausting operating system and network resources, resulting in failures such as “cannot fork”, “no free file handles”, “can not create socket”, “malloc: out of memory”, etc.

The problem is that legitimate requests are used in the attack and the attack is performed by multiple computers/hackers, not just one or two. Moreover, legitimate requests are mixed in with the DDOS attack. Thus, DDOS attacks are difficult to detect until its too late. Typically, system personnel will try to disable requests coming from a section of the Internet to mitigate a DDOS attack.

### BRIEF SUMMARY OF THE INVENTION

One embodiment of the invention is a method of responding to a browser request by a server comprising: reading a current load factor for the server, determining a quality of service level for a user that originated the browser request, determining a delay based upon the current load factor and the quality of service, delaying handling of the request by the server with the delay.

Another embodiment of the invention is a method of handling a distributed denial of service attack on a server involving a plurality of requests comprising: determining a number of transactions on the server, if the number of transactions exceeds a predetermined value, then setting a current load factor of the server to a predetermined value, and delaying handling of at least a portion of the plurality of requests with the current load factor.

A further embodiment of the invention is a web server comprising: means for receiving at least one information request from a user, means for forming a response to the information request, means for sending the response to the user, and means for delaying the receipt of the response by the user.

### BRIEF DESCRIPTION OF THE DRAWINGS

FIG. 1 depicts an example of a method of using quality of service levels in processing a web server request, according to embodiments of the invention;

FIG. 2 depicts an example of block 101 of FIG. 1, according to embodiments of the invention;

FIGS. 3A and 3B depict examples of methods for determining the current load factor, according to embodiments of the invention;

FIG. 4 depicts an example of blocks 103 and 104 of FIG. 1, according to embodiments of the invention;

FIG. 5 depicts an example of a method for handling a DDOS attack, according to embodiments of the invention;

FIG. 6 depicts a system that uses quality of service levels in processing a web server request, according to embodiments of the invention; and

FIG. 7 depicts a block diagram of a computer system which is adapted to use the present invention.

### DETAILED DESCRIPTION

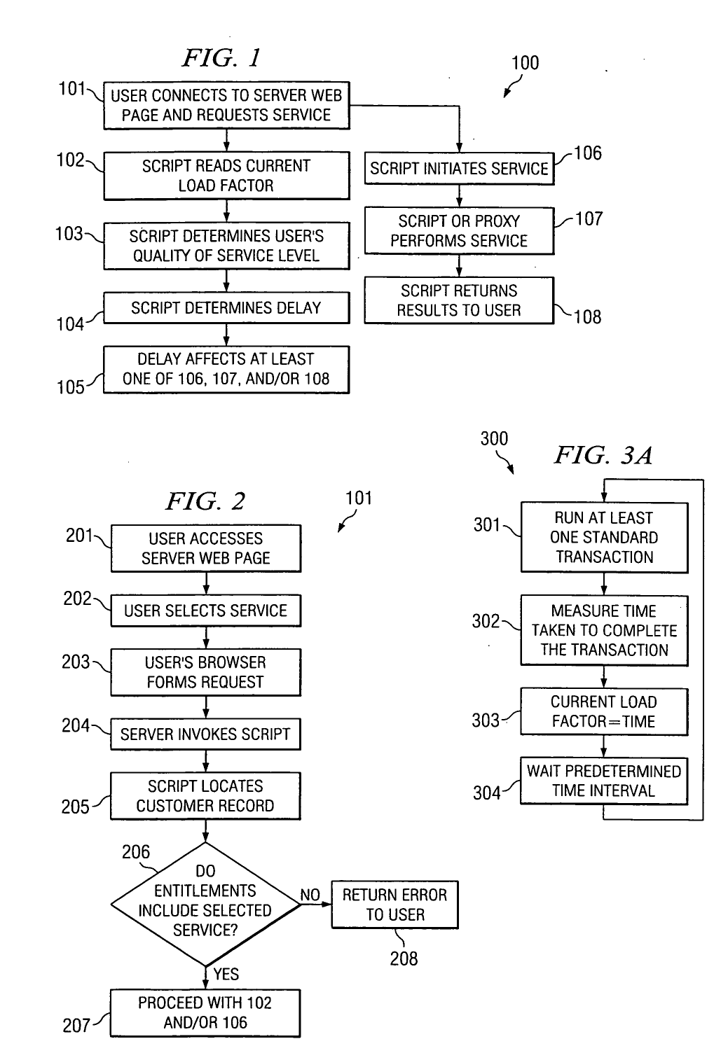

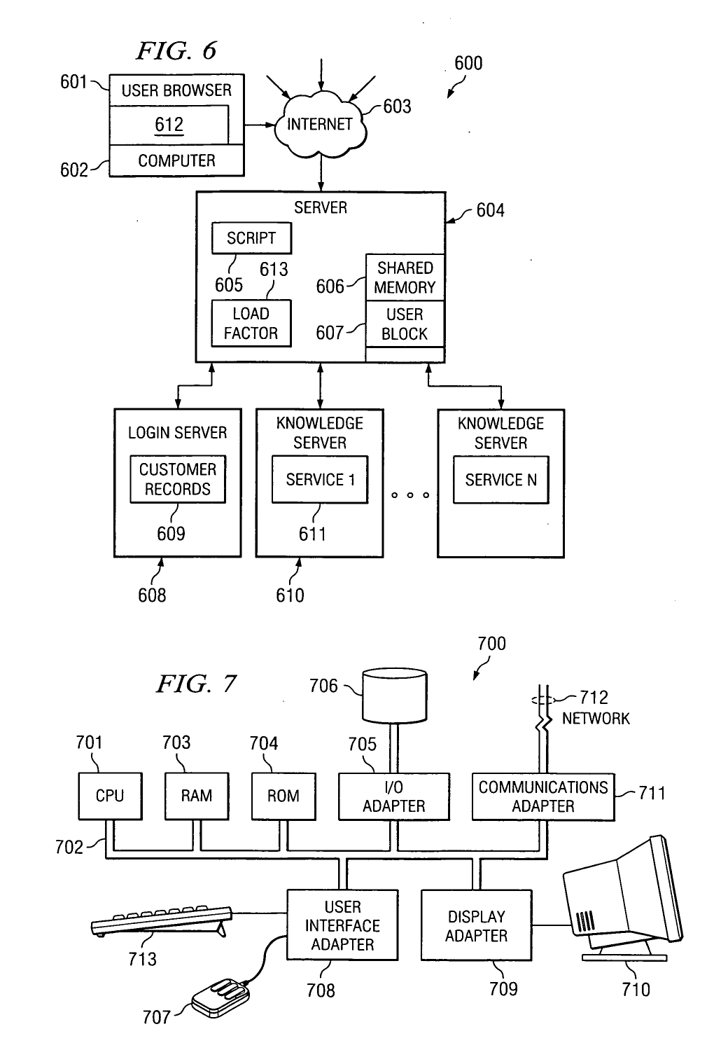

FIG. 1 depicts an example of a method 100 of using quality of service levels in processing a web server request, according to embodiments of the invention. FIG. 6 will be discussed in conjunction with FIGS. 1, 2, 3A, 3B, 4, and 5. FIG. 6 depicts a system that uses quality of service levels in processing a web server request, according to embodiments of the invention. The method 100 presumes that the server 604 is using shared memory 606, and the user has initiated a previous login such that the user's browser 601 includes a cookie 612 that includes a pointer to the user's assigned shared memory block 607. However, this is by way of example only as other ways of retaining and fetching customer information may be used, e.g. the customer record 609 may be fetched from login server 608. Also note that this method involves the Internet 603, but this is by way of example only as other networks may be used, e.g. a local area network, a wide area network, a wireless network, a satellite network, and a radio network.

The method begins when the user connects to a web page of a web site and request a service, block 101. The service may be a search, a download request (for a picture(s), document(s), article(s), and/or text), a purchase, a sale, a trade, an auction bid, an account query, an account transaction, entry into a community, entry into a chat room, access to the Usenet, access to a web page, access to a program, or other HTTP transaction.

The request invokes the script 605 in server 604 to initiate the requested service, block 106. Either the script 605 or another function (e.g. another script, DLL, proxy, etc.) performs the service, block 107, the script then returns the results to the user 108.

The script 605 also reads the current load factor, block 102. Note that this script 605 may be the same script involved with block 106, or it may be a different script. The current load factor may be stored in a memory location 613, e.g. a register, in the server 604. The script also determines the users quality of service level for the user, block 103. For example, there may be three levels of service, namely gold (highest), silver (middle), and bronze (lowest). A user would have the lowest level, i.e. bronze, unless the user purchases a higher level of service, i.e. either silver or gold. Note that this is by way of example only as fewer or more quality levels may be used. The quality of service level for the user is stored in the customer records 609, a copy of which would have been saved in the user's block 607 of shared memory 606. Note that using shared memory will speed up this operation, as a fetch from shared memory takes less time than a fetch from another server, e.g. login server 608. The customer record may be retrieved from either location.

From the current load factor and the quality of service level, the script determines an amount of delay to associate with the request, block 104. Since computer system generally operate as fast as possible, it is difficult to increase the speed of the system for higher quality service levels, instead embodiments add a delay to the lower quality service level. For example, gold would have no added delay, silver may have an added delay equal to twice the current load factor, and bronze may have an added delay equal to thrice the current load factor. In block 105, the delay is then used to affect the starting, the operating, and/or the completion of one or more of blocks 106, 107, and/or 108.

Note that blocks 102, 103, 104, and 105 may be performed before, during, or after blocks 106 and 107. For example, if it is desired to delay the start of block 106, then blocks 102-105 should be completed prior to the start of block 106. Thus, the delay may be used to delay the script from initiated the requested service for silver and bronze level users. Alternatively, it may be desired to delay the return of the results to the user. This has the effect of processing the higher level requests before the lower level requests. Thus, the blocks 102, 103, 104, and 105 may be processed prior to, during (e.g. intermixed), or after the processing of blocks 106 and 107. In this case, the results may be delayed for silver and bronze level users.

Note that the delay may be changed on a per-user basis instead of or in addition to the per server basis. For example, suppose computer 602 is owned by Acme, Inc. Acme may wish to deliver premium (gold) service to its own employees, whether or not they have a service contract. Thus, a user whose web browser request originates from an Acme network computer may always receive gold level of service, via logic in script 605. On the other hand, a request from a rival, Widget Corp. computer, may have an added additional delay factor because the request came from a web browser in the rival company's network. This added delay would be removed if Widget Corp. paid for certain quality of service level.

FIG. 2 depicts an example of block 101 of FIG. 1, according to embodiments of the invention. Again, this method 101 presumes that the server 604 is using shared memory 606, and the user has initiated a previous login such that the user's browser 601 includes a cookie 612 that includes a pointer to the user's assigned shared memory block 607. However, this is by way of example only as other ways of retaining and fetching customer information may be used, e.g. the customer record 609 may be fetched from login server 608. Also note that this method involves the Internet 603, but this is by way of example only as other networks may be used, e.g. a local area network, a wide area network, a wireless network, a satellite network, and a radio network.

In block 201, the user accesses a server web page. The user selects a service, block 202. The service may involve back-end servers, e.g. knowledge server 610, having service 1 611. In block 203, the user's browser 601 forms a request, if the system is using shared memory, then the request will include the cookie having the location of the user's block 607. The server, in response to the request, invokes script 605 in block 204. In block 205, the script, using the cookie, locates the customer record in user block 607. (Note that if shared memory is not used, then the script may locate the customer record 609 in login server 608.) In block 206, the script determines whether the user is allowed to access the requested service. If so, then in block 207, the script continues with block 102 and/or block 106. If not, then in block 208, the script may return an error message to the user, e.g. sorry your service contract does not allow access to this service.

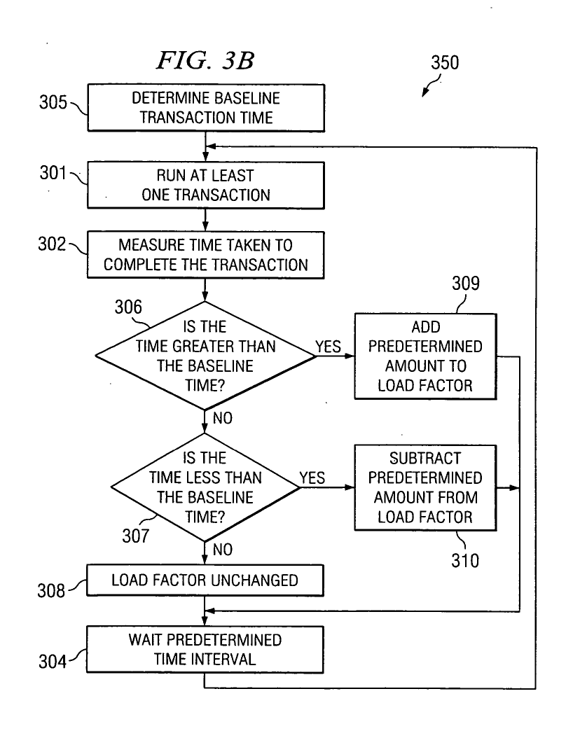

FIGS. 3A and 3B depict examples of method for determining the current load factor, according to embodiments of the invention.

In FIG. 3A, the method 300 begins with a script 605 on the server 604 that runs at least one standard transaction, e.g. a search, block 301. Note that script 605 may be the same script associated with blocks 102, 103, and/or 106, or it may be a different script. The script would then measure the time taken to complete the transaction, e.g. 30 seconds, block 302. The script would then set the current work load factor equal to the time taken to complete the transaction, block 303. In block 304, the script would then wait a predetermined amount of time, e.g. 2 minutes, before returning to block 301. This builds a hysteresis into the method 300. This prevents the current work load factor from being changed because of momentary peaks or dips in the work load. In other words, the user will not perceive great fluctuations in performance for consecutive transactions.

Thus, if the server is lightly loaded, then the delays will be small. If the server is heavily loaded, then the delays will be larger.

FIG. 3B depicts an alternative to the method of FIG. 3A. In block 305 of method 350, a script 605 will determine a baseline transaction time, wherein the script runs at least one standard transaction, and notes the amount of time taken to complete the transaction. To serve as the baseline, this transaction should be run while the server is under an average work load. This block may be performed separately from the remainder of the method. Note that script 605 may be the same script associated with blocks 102, 103, 106, and/or 301, or it may be a different script. The script then runs at least one standard transaction, e.g. a search, block 301. The script would then measure the time taken to complete the transaction, e.g. 30 seconds, block 302. The method then determines whether the measured time is greater than the baseline time, block 306. If so, then the method adds a predetermined amount to the current load factor, e.g. 0.5 seconds, block 309. If not, then the method then determines whether the measured time is less than the baseline time, block 307. If so, then the method subtracts a predetermined amount from the current load factor, e.g. 0.5 seconds, block 310. If not, then current load factor is unchanged, block 311. After completion of blocks 308, 309, 310, the method the script would then wait a predetermined amount of time, e.g. two minutes, before returning to block 301. This builds a hysteresis into the method 350. This prevents the current work load factor from being rapidly changed because of momentary peaks or dips in the work load. In other words, the user will not perceive great fluctuations in performance for consecutive transactions. Note that the transactions of block 301 for FIGS. 3A and 3B are not encumbered by delays of block 105. This would provide an inaccurate measurement of the system work load.

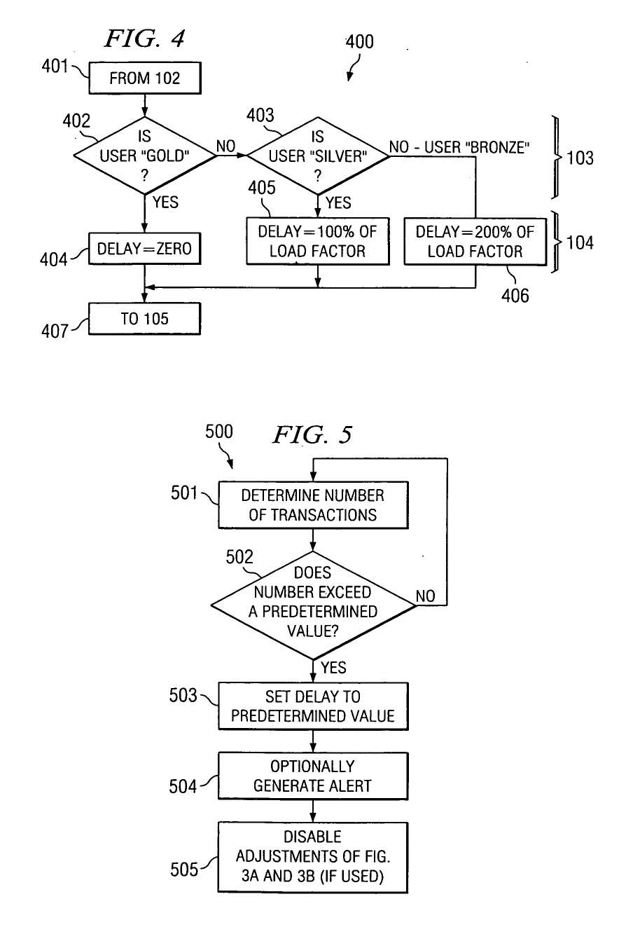

FIG. 4 depicts an example of a method 400 of blocks 103 and 104 of FIG. 1, according to embodiments of the invention. In block 401, the method 400 begins after processing of block 102. The method determines whether the user has a gold level of quality of service, block 402. If so, the delay is zero, block 404, and processing continues in block 407 with block 105. If not, then the method determines whether the user has a silver level of quality of service, block 403. If so, the delay is a predetermined number, for example 100% of the load factor, block 405, and processing continues in block 407 with block 105. If not, then the user has a bronze level of quality of service, and the delay is a predetermined number, for example 200% of the load factor, block 406, and processing continues in block 407 with block 105.

FIG. 5 depicts an example of a method 500 for handling a DDOS attack, according to embodiments of the invention. This method 500 handles distributed denial of service (DDOS) attacks from hackers and/or predatory programs, e.g. viruses. The method uses a script 605 to determine the number of request that are being processed by the server, block 501. The script may monitor the total number of requests or a number of requests per time period, e.g. number per minute. Note that script 605 may be the same script associated with any of blocks 102, 103, 106, 301 and/or 305, or it may be a different script. The script then determines if the number exceeds a predetermined value, e.g. 2000 and/or 100 per minute, block 502. If not, then the method returns to block 501.

If so, then there may be a DDOS attack taking place. The method then sets the load factor to a predetermined value, e.g. 3 minutes, block 503. This will slow down processing of the requests and prevent the server and/or backend server(s) from crashing. An aggressive value (e.g. 3 minutes) will be more likely to prevent a crash, than a gentle delay, e.g. 10 seconds. This method is most efficient when the delay of block 105 is used to delay the start of block 106. The method then may optionally generate an alert to warn system personnel of the attack, block 504. In block 505, the method may then optionally disable the work load adjustments of FIGS. 3A and 3B (if used), until the attack has ceased. The method may monitor the situation, and then restore the system when the attack is ceased, or the method may maintain the defensive posture until system personnel reset the system.

Note that the delay of block 503 may be made to only impact the lowest level of quality of service, namely the bronze level. It is unlikely that paying users (e.g. gold and silver) would be involved in the attack, at least as hackers. While their computers may be infected with a virus that causes their computer to be involved in the attack without the user's knowledge, this risk is relatively low. Most of the computer involved in the attack will be at the bronze level or free users. This would allow for the paying users to still have their legitimate requests processed, while blunting the effects of the attack. Note that this method may also be useful to handle unexpected events or known peak traffic time. For example, a weather web site may be besieged by legitimate requests of users seeking information about an approaching hurricane. Also note that the delay added may be staggered, e.g. one group receives 3 minutes of delay, another group receives 6 minutes of delay, a further group receives 9 minutes of delay, etc. This would prevent the requests from being processed all at the same time.

Also note that the method may be modified to track the number of transactions each user if requesting, if the user is requesting an excessive number, then the delay may be imposed only as to that user. This would allow the DDOS protection to be applied only to those users who are generating an excessive number of requests. This value may be determined for each transaction type, in each service area.

Note that any of the scripts, functions, and/or methods described herein may be implemented in hardware, software, and/or firmware, and/or any combination thereof. When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

FIG. 7 illustrates computer system 700 adapted to use the present invention. Central processing unit (CPU) 701 is coupled to system bus 702. The CPU 701 may be any general purpose CPU, such as an HP PA-8500 or Intel Pentium processor. However, the present invention is not restricted by the architecture of CPU 701 as long as CPU 701 supports the inventive operations as described herein. Bus 702 is coupled to random access memory (RAM) 703, which may be SRAM, DRAM, or SDRAM. ROM 704 is also coupled to bus 702, which may be PROM, EPROM, or EEPROM. RAM 703 and ROM 704 hold user and system data and programs as is well known in the art.

Bus 702 is also coupled to input/output (I/O) controller card 705, communications adapter card 711, user interface card 708, and display card 709. The I/O adapter card 705 connects to storage devices 706, such as one or more of a hard drive, a CD drive, a floppy disk drive, a tape drive, to the computer system. The I/O adapter 705 is also connected to printer (not shown), which would allow the system to print paper copies of information such as document, photographs, articles, etc. Note that the printer may be a printer (e.g. dot matrix, laser, etc.), a fax machine, or a copier machine. Communications card 711 is adapted to couple the computer system 700 to a network 712, which may be one or more of a telephone network, a local (LAN) and/or a wide-area (WAN) network, an Ethernet network, and/or the Internet network. User interface card 708 couples user input devices, such as keyboard 713, pointing device 707, and microphone 716, to the computer system 700. User interface card 708 also provides sound output to a user via speaker(s) 715. The display card 709 is driven by CPU 701 to control the display on display device 710.

1. A method of responding to a browser request by a server comprising:
reading a current load factor for the server;
determining a quality of service level for a user that originated the browser request;
determining a delay based upon the current load factor and the quality of service; and
delaying handling of the request by the server with the delay.

2. The method of claim 1, further comprising:
determining the current load factor.

3. The method of claim 2, wherein determining the current load factor comprises:
executing at least one transaction;
measuring an amount of time to complete the one transaction; and
setting the current load factor to a value based on the amount of time.

4. The method of claim 3, wherein determining the current load factor further comprises:
repeating the executing, the measuring, and the setting after a predetermined time period.

5. The method of claim 2, wherein determining the current load factor comprises:
executing at least one transaction;
measuring an amount of time to complete the one transaction;
setting the current load factor to a value based on the amount of time;
if the amount of time is greater than baseline time, adding a predetermined value to the load factor; and
if the amount of time is less than baseline time, subtracting a predetermined value to the load factor.

6. The method of claim 5, wherein determining the current load factor further comprises:
repeating the executing, the measuring, and the setting after a predetermined time period.

7. The method of claim 1, wherein handling the request comprises:
initiating processing of the request;
processing the request; and
sending a result of the request back to the user.

8. The method of claim 7, wherein delaying handling of the request by the server with the delay comprises:
delaying at least one of initiating processing of the request, processing the request, and sending a result of the request back to the user.

9. The method of claim 1, further comprising:
connecting to the server, by the user, to request a service on the server.

10. The method of claim 9, further comprising:
returning an error to the user if the requested service is not associated with a permitted entitlement of the user.

11. The method of claim 1, wherein reading a current load factor for the server comprises:
reviewing a record associated with the user in a database.

12. The method of claim 1, wherein there are at least three levels of service including a lowest level, a middle level, and a highest level, and wherein determining a delay based upon the current load factor and the quality of service comprises:
setting a delay equal to zero if the quality of service level is the highest level;
setting a delay equal to the load factor if the quality of service level is the middle level; and
setting a delay equal to twice the load factor if the quality of service level is the lowest level.

13. A method of handling a distributed denial of service attack on a server involving a plurality of requests comprising:
determining a number of transactions on the server;
if the number of transactions exceeds a predetermined value, then setting a current load factor of the server to a predetermined value; and
delaying handling of at least a portion of the plurality of requests with the current load factor.

14. The method of claim 13, wherein delaying handling comprises:
delaying at least one of initiating processing of the portion of the plurality of requests, processing the portion of the plurality of requests, and sending results of the portion of the plurality of requests back to originators of the requests.

15. The method of claim 13, further comprising:
sending an alert to at least one server person warning of the distributed denial of service attack.

16. A web server comprising:
means for receiving at least one information request from a user;
means for forming a response to the information request;
means for sending the response to the user; and
means for delaying the receipt of the response by the user.

17. The web server of claim 16, wherein the means for delaying comprises:
means for delaying the means for sending.

18. The web server of claim 16, wherein the means for delaying comprises:
means for delaying the means for forming.

19. The web server of claim 16, wherein the means for delaying is operative to delay the response during a distributed denial of service attack on the server.

20. The web server of claim 16, wherein the means for delaying is operative to delay the response based upon a quality of service level associated with the user.
